(19) United States
(12) Patent Application Publication
(10) Pub. No.: US 2009/0145976 A1
(43) Pub. Date: Jun. 11, 2009

(54) Paint Supply System

(75) Inventors: Hirotaka Takeguchi, Tokyo (JP); Toshinao Komada, Tokyo (JP); Jun-ichi Suzuki, Tokyo (JP)

Correspondence Address: BIRCH STEWART KOLASCH & BIRCH, PO BOX 747, FALLS CHURCH, VA, 22040-0747, US

(73) Assignee: Honda Motor Co., Ltd., Minato-ku, TOKYO (JP)

(21) Appl. No.: 12/085,756

(22) PCT Filed: Nov. 29, 2006
(86) PCT No.: PCT/JP2006/323761

§ 371 Date: Nov. 18, 2008

(30) Foreign Application Priority Data
Dec. 2, 2005 (JP) 2005-349079

(51) Int. Cl. B05B 12/14

(52) U.S. Cl. 239/104; 239/407

(57) ABSTRACT

There is provided a paint supply system in which a paint passage is less liable to be clogged with peeled-off deposits even when paint piping and the like are cleaned with a pig, and the substantially entire region of circulation piping can be cleaned efficiently and surely. In a paint supply system 1 in which color change valves 4 are connected to intermediate portions of closed loop paint circulation piping 3 extending from a paint tank 2 and returning to the paint tank 2 and a paint gun 5 is connected to each of the color change valves 4, a pig launching valve 25 is provided at a position on the upstream side of the paint circulation piping 7 at which a pig 27 can be launched linearly and which is closest to a paint pressure feed pump 6, and a pig discharging valve 26 is provided at a position on the downstream side of the circulation piping 7 at which the pig 27 can be discharged linearly and which is closest to the paint tank 2. A first opening 10k on the upstream side of the color change valve 4 is provided at a position close to the inner wall of a through hole h constituted as a part of the circulation piping 3 so that no space is allowed between the inner wall and the first opening 10k.

### TECHNICAL FIELD

The present invention relates to a paint supply system in which a paint of a desired color is selected from paints of various colors fed from, for example, a plurality of paint supply sources, and is fed to a paint gun. More particularly, it relates to a technique capable of surely cleaning the inner wall of closed loop paint circulation piping connected to the paint supply source of the paint supply system.

### BACKGROUND ART

Conventionally, in a body painting process for motor vehicles, a technique in which a plurality of painting robots each having a paint gun are provided in a painting booth, and paint is supplied to the paint gun by a paint supply system has generally been in widespread use. Such a paint supply system is configured so that paint tanks containing paints of various colors are provided in a paint mixing chamber, closed loop paint circulation piping is connected to each of the paint tanks to form a circuit capable of circulatingly supplying paint to the painting booth, and a color change valve capable of selecting a paint of a desired color from the paints is connected to an intermediate portion of the circulation piping, by which paints of a plurality of colors can be sprayed to a vehicle body, which is conveyed in succession into the painting booth, by using the same paint gun. Such a paint is circulated in the paint circulation piping at the time other than painting time to prevent the pigment component in the paint from settling. For this purpose, a valve for opening and closing a paint passage is provided between the circulation piping and the color change valve, and at the time of painting, by the changeover of this valve, the paint is fed into the paint passage of a manifold on the downstream side of the color change valve, and is supplied to the paint gun.

In the above-described paint supply system, the painting booth is generally located at a place distant from the paint mixing chamber. Accordingly, the paint circulation piping is long, so that on the inner wall of the paint circulation piping, paint deposits with time. If the deposits are left as they are, the inside diameter of the circulation piping decreases, and therefore the flow rate of paint decreases. As a result, the spray pattern becomes irregular, thereby producing unevenness of coating, or the deposits peeled off the wall surface during the painting work are mixed in the paint and sprayed to an article to be painted, which presents a problem of degraded painting quality and the like problem. To solve these problems, a technique of cleaning the interior of the circulation piping by running a pig has been used. As such a technique, there have been known a technique in which in a paint supply system provided with a color change valve that enables circulation piping (a first flow path) and a manifold (a second flow path) to be opened and closed by using a valve and a paint mask sheet, a pig is run in the state in which the circulation piping is closed by the paint mask sheet of a fluid selector module, by which the interior of pipe is cleaned (for example, refer to Patent Document 1), and a technique in which a pig station is provided in an intermediate portion of closed loop common circulation piping that allows paints of various colors, thinner, etc. to flow commonly, and a pig in the pig station is run regularly in the common circulation piping, by which the interior of piping is cleaned (for example, refer to Patent Document 2).

### Patent Document 1: Japanese Patent Application Publication No. 2003-190850

### Patent Document 2: Japanese Patent Application Publication No. 2002-239489

In the technique disclosed in Patent Document 1, the paint mask sheet of the fluid selector module for closing the circulation piping is present on the manifold side on the inside of the circulation piping, and a passage having a fixed length is formed between the circulation piping and the paint mask sheet, so that a problem arises in that highly viscous paint residues etc. peeled off by the pig enter into this passage having the fixed length to clog the passage.

Also, in the technique disclosed in Patent Document 2, if it is attempted to apply this technique to a system configuration in which circulation piping is provided for each paint color, the pig station and the pig must be provided for each circulation piping, which poses a problem of increased equipment cost. Also, in the case where the passage in which the pig does not run ranging from the paint tank to the circulation piping is long, this passage must be cleaned. If a cleaning mechanism is provided separately for this purpose, there arises a problem in that the system configuration is complicated, and the cleaning work is troublesome.

### DISCLOSURE OF THE INVENTION

Accordingly, an object of the present invention is to provide a paint supply system in which a paint passage is less liable to be clogged with deposits peeled off at the time of pig cleaning, and the substantially entire region of circulation piping can be cleaned efficiently and surely.

To achieve the above object, the present invention provides a paint supply system in which a paint gun is connected to an intermediate portion of closed loop paint circulation piping, which is connected to a paint supply source, via a color change valve, and when the paint circulation piping is cleaned, a pig is run in the circulation piping, characterized in that in the intermediate portions of the paint circulation piping, a pump for feeding paint under pressure, a pig launching valve for launching the pig into the circulation piping, and a pig discharging valve for discharging the pig from the circulation piping are provided; the pig launching valve is provided at a place closest to the pump of the places where the pig can be launched into the paint circulation piping almost linearly; and the pig discharging valve is provided at a place closest to the paint supply source of the places where the pig can be discharged from the paint circulation piping almost linearly.

When the interior of the paint circulation piping is cleaned, after the pig has been launched from the pig launching valve, the pig is run in the circulation piping by a cleaning solution or an air pressure to remove deposits adhering to the inner wall etc., and then the pig in the circulation piping is recovered through the pig discharging valve.

At this time, the pump for feeding paint under pressure is usually arranged at a position closest to the paint supply source. Therefore, the pig launching valve and the pig discharging valve are disposed at positions close to the paint supply source, so that the substantially entire region of the circulation piping can be cleaned efficiently. Also, even in the case where the circulation piping is provided for each paint color, only the pig launching valve and the pig discharging valve are provided in advance, and separately, the pig is launched and discharged through the pig launching valve and the pig discharging valve, by which the equipment can be configured simply at a low cost.

Also, the pig is launched into or discharged from the circulation piping almost linearly, so that the pig can be run smoothly.

Also, in the present invention, the color change valve has a valve body capable of feeding the paint, which is fed from the paint circulation piping, into the paint passage of a manifold via a communication passage; the valve body is provided with a first needle valve which can open and close a first opening which is open to the paint circulation piping from the communication passage in the valve body and a second needle valve which can open and close a second opening which is open to the paint passage in the manifold from the communication passage in the valve body; and at least the first opening is arranged at a position close to the inner wall of the paint circulation piping.

The first opening is positioned close to the inner wall of the paint circulation piping, and a passage between the first opening and the circulation piping is substantially eliminated. Therefore, even when the paint residues depositing on the inner wall of the circulation piping are peeled off by the pig, a trouble such that the peeled-off highly viscous paint residues accumulate in the passage is prevented.

In the closed loop paint circulation piping, the pig launching valve is provided at a location close to the paint pressure feed pump, and the pig discharging valve is provided at a location close to the paint supply source. The pig is launched from the pig launching valve almost linearly, and is discharged from the pig discharging valve linearly to clean the interior of the paint circulation piping. Thereby, the substantially entire region of the circulation piping can be cleaned surely, and moreover, the system can be configured at a low cost.

Of the communication passage of the valve body of the color change valve, the position of the first opening that is open toward the circulation piping is brought close to the inner wall of the circulation piping. Thereby, when the circulation piping is cleaned with the pig, a trouble such that the removed paint residues accumulate and clog the paint passage can be prevented.

### BRIEF DESCRIPTION OF THE DRAWINGS

FIG. 1 is a schematic view showing a configuration of circulation piping for a paint of a certain color in a paint supply system in accordance with the present invention;

FIG. 2 is an explanatory view of a color change valve that is viewed from the direction A in FIG. 1;

FIG. 3 is an explanatory view of a color change valve that is viewed from the direction B in FIG. 2;

FIG. 4 is a sectional view taken along the line C-C of FIG. 2;

FIG. 5 is a sectional view taken along the line D-D of FIG. 2;

FIG. 6 is an explanatory view of a pig launching valve, showing a state in which a sleeve for launching a pig is removed; and

FIG. 7 is an explanatory view of a pig launching valve, showing a state in which a sleeve for launching a pig is mounted.

### BEST MODE FOR CARRYING OUT THE INVENTION

An embodiment of the present invention will now be described with reference to the accompanying drawings.

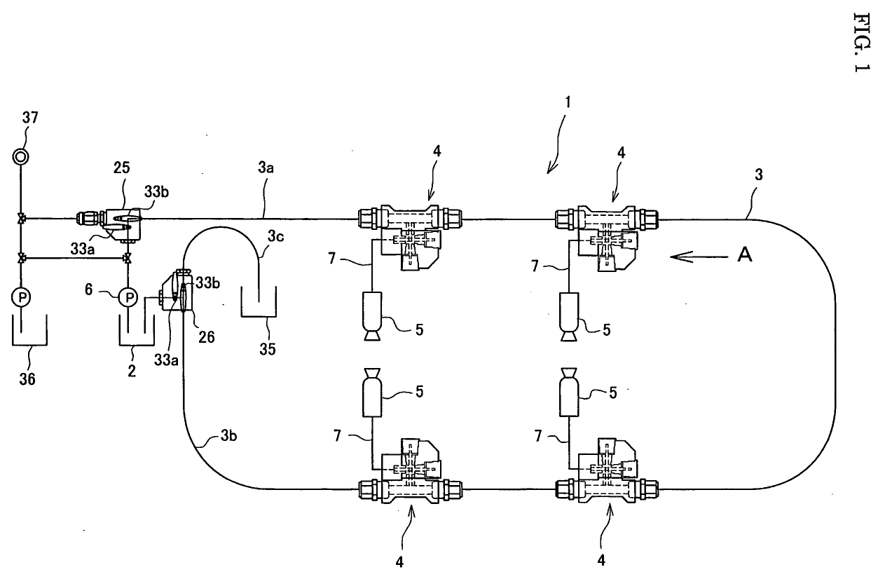

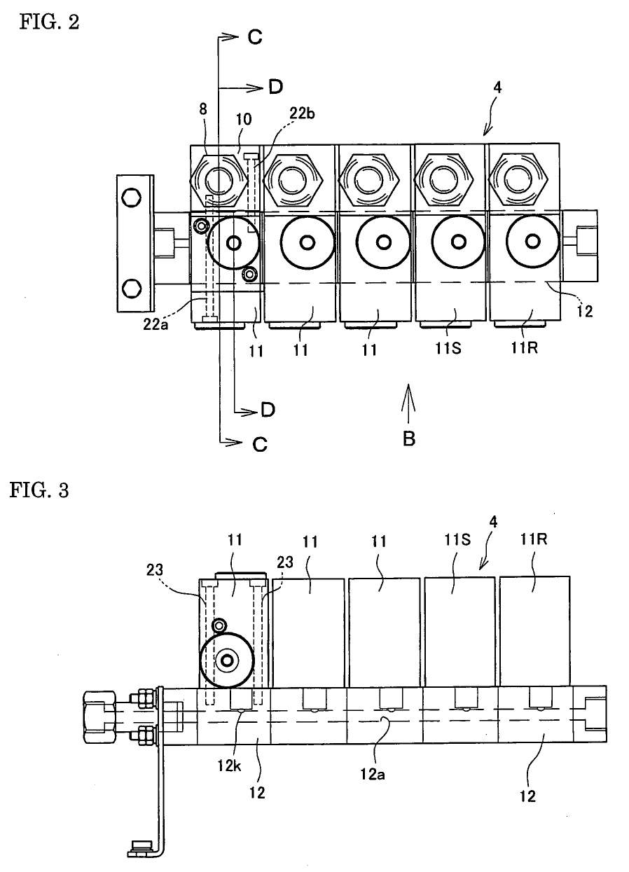

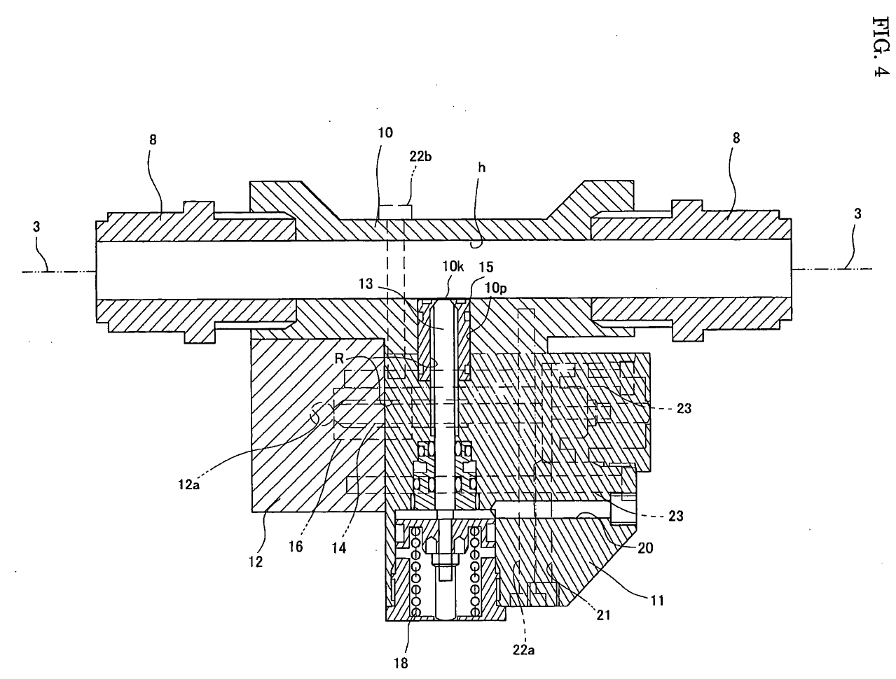

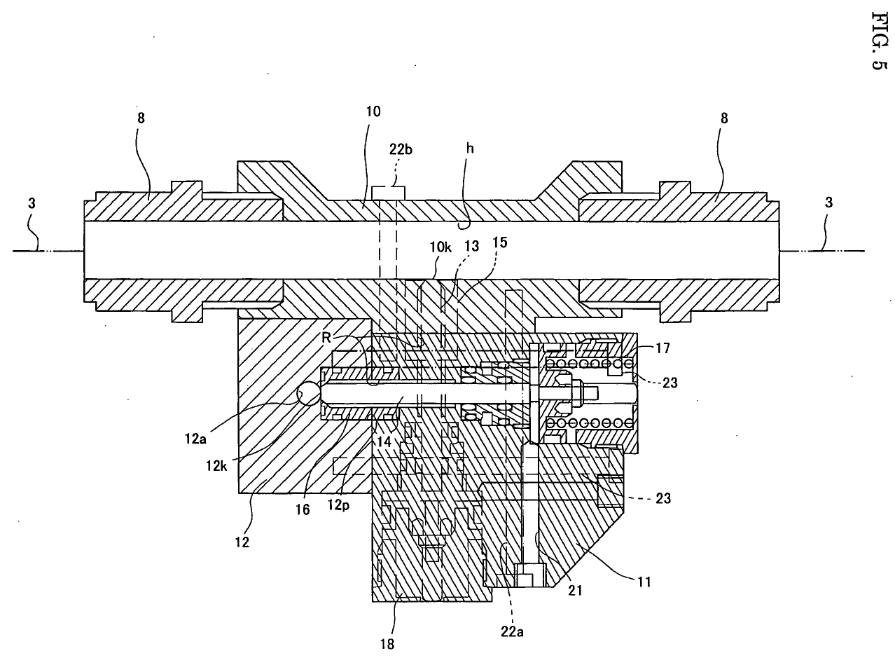

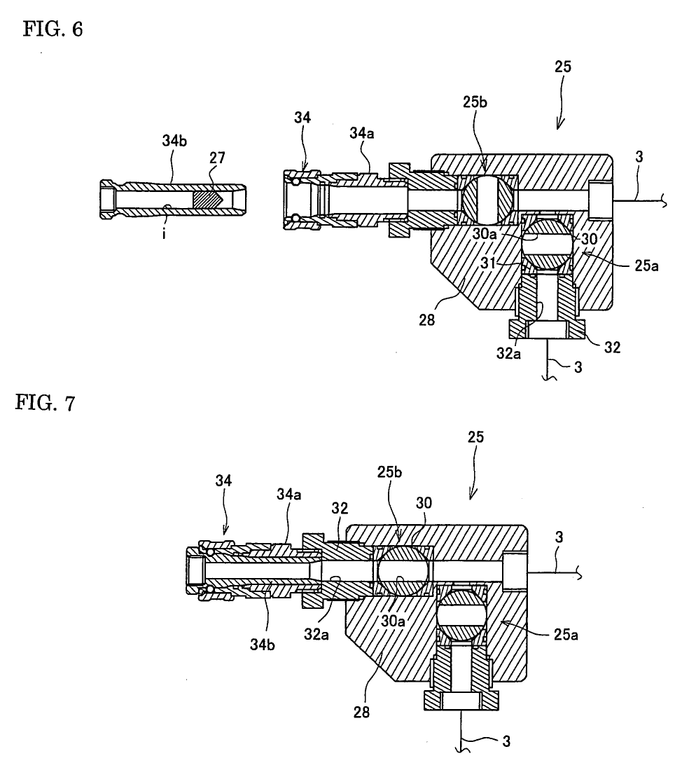

FIG. 1 is a schematic view showing a configuration of circulation piping for a paint of a certain color in a paint supply system in accordance with the present invention, FIG. 2 is an explanatory view of a color change valve which is viewed from the direction A in FIG. 1, FIG. 3 is an explanatory view of a color change valve which is viewed from the direction B in FIG. 2, FIG. 4 is a sectional view taken along the line C-C of FIG. 2, FIG. 5 is a sectional view taken along the line D-D of FIG. 2, and FIGS. 6 and 7 are explanatory views of a pig launching valve.

The paint supply system in accordance with the present invention is configured as a system for supplying paint to a paint gun in a painting booth used, for example, the painting process for a vehicle body. The paint supply system is configured so that when a plurality of sets of paint circulation piping laid from a paint mixing chamber to the painting booth are cleaned with a pig, a paint passage is less liable to be clogged with peeled-off deposits, and the substantially entire region of the circulation piping can be cleaned efficiently and surely, and moreover is configured so as to be simple.

As shown in FIG. 1, the paint supply system 1 of this embodiment includes paint circulation piping 3 extending from a paint tank 2 serving as a paint supply source, a plurality of color change valves 4 connected to intermediate portions of the paint circulation piping 3, and a plurality of paint guns 5 that are connected to the color change valves 4 via connection hoses 7 and are disposed in the painting booth. The paint tank 2 is disposed in the paint mixing chamber at a place sufficiently distant from the painting booth. A plurality of paint tanks 2 corresponding to various paint colors and a plurality of sets of the paint circulation piping 3 extending from the paint tanks 2 are provided. The plurality of sets of the paint circulation piping 3 corresponding to these colors can be selected by the color change valve 4, so that a paint of each color can be supplied selectively to the same paint gun 5. The paint supply system shown in FIG. 1 typically shows a case of a paint of a certain color.

A pump 6 for feeding paint under pressure is connected to a location in an intermediate portion of an outward pipe 3a extending from the paint tank 2 of the paint circulation piping 3 and closest to the paint tank 2, and the paint circulation piping 3 is formed into a closed loop shape so that after passing through connection parts connected with the plurality of color change valves 4, the paint is returned to the paint tank 2 through a return pipe 3b. The paint in the paint tank 2 is always sucked and fed under pressure by the operation of the pump 6, and is caused to flow from the outward pipe 3a to the return pipe 3b and returned into the paint tank 2 even when painting is not performed. Thereby, pigment component particles etc. of paint are prevented from settling.

At the time of painting, a paint of any color is selected by the color change valve 4, being supplied to the paint gun 5 via the connection hose 7, and is sprayed from the paint gun 5.

As shown in FIGS. 2 to 5, the color change valve 4 has a valve body 11 that is connected to an intermediate portion of the paint circulation piping 3 via joints 8 and a connection member 10. The connection member 10 and the joints 8 each are formed with a through hole h having a diameter equal to the inside diameter of the paint circulation piping 3. This through hole h is formed as a part of the paint circulation piping 3, and as shown in FIGS. 2 and 3, the valve body 11 is arranged in plural numbers according to the number of sets of the paint circulation piping 3 for every paint color, and also an air operate type valve body 11S for supplying air and a valve body 11R for supplying thinner are arranged side by side.

To each of the valve bodies 11, 11S and 11R, a manifold 12 is connected, and the manifolds 12 are connected linearly to each other. Paint passages 12a formed in the manifolds 12 communicate with each other as one passage, and this one paint passage 12 is connected to the paint gun 5 via the connection hose 7 (FIG. 1).

As shown in FIGS. 4 and 5, the valve body 11 has valve seats 15 and 16 fitted in a port 10p that is provided in the connection member 10 so as to be open toward the through hole h in the connection member 10 and a port 12p provided in the manifold so as to be open toward the paint passage 12a in the manifold 12, respectively. These valve seats 15 and 16 are provided in the directions different through 90 degrees, and in the valve body 11, a crank-shaped communication passage R connecting the valve seats 15 and 16 to each other by means of a bent passage is provided. In the communication passage R, a first needle valve 13 and a second needle valve 14 are provided in a cross shape in such a manner that the phases thereof shift from each other.

The first and second needle valves 13 and 14 are urged forward by springs 17 and 18, respectively, so that the tip ends thereof are always in contact with the valve seats 15 and 16, respectively. That is to say, the first needle valve 13 closes a first opening 10k communicating with the connection member 10 side, and the second needle valve 14 closes a second opening 12k communicating with the manifold 12 side. Also, when the first and second openings 10k and 12k are opened by retreating the needle valves 13 and 14, the needle valves 13 and 14 are retreated against the urging force of the springs 17 and 18 by providing air supply holes 20 and 21 for supplying compressed air from an air supply source, not shown, so that compressed air is supplied through the air supply holes 20 and 21.

The first opening 10k on the connection member 10 side is provided at a position close to the inner wall of the through hole h in the connection member 10. When the paint circulation piping 3 and the through hole h are cleaned with a pig 27, described later, a space in which peeled-off paint residues accumulate is prevented from being formed in front of the first opening 10k.

The connection member 10 is connected to the valve body 11 by a plurality of bolts 22a and 22b, and the manifold 12 is connected to the valve body 11 by a plurality of bolts 23.

In the color change valve 4 described above, when painting is not performed, the first and second needle valves 13 and 14 are in contact with the valve seats 15 and 16, respectively, to close the first and second openings 10k and 12k, so that the paint flowing in the paint circulation piping 3 is returned to the paint tank 2 as it is.

When painting is performed, compressed air is sent through the air supply ports 20 and 21 to retreat the first and second needle valves 13 and 14, and paint is fed into the paint passage 12a in the manifold 12 through the communication passage R to spray the paint from the paint gun 5.

Next, a pig cleaning means is explained.

As shown in FIG. 1, the pig cleaning means includes a pig launching valve 25 that can launch the pig almost linearly into the paint circulation piping 3 on the upstream side and is provided on the outward pipe 3a closest to the pump 6, a pig discharging valve 26 that can discharge the pig almost linearly from the paint circulation piping 3 on the downstream side and is provided on the return pipe 3b closest to the paint tank 2, a cleaning solution supply part 36 for supplying a cleaning solution under pressure via a pump, and an air supply part 37 for supplying compressed air, so that the pig 27, the cleaning solution, and the air are caused to flow in the paint circulation piping 3 between the pig launching valve 25 and the pig discharging valve 26 and thereby the paint depositing on the inner wall surface of the circulation piping 3 and the through hole h of the connection member 10 can be cleaned.

As shown in FIG. 6, the pig launching valve 25 includes a first selector valve 25a that can shut off or open a paint flow path on the paint tank 2 side and a second selector valve 25b that can change the passage leading to the circulation piping 3 when the pig 27 is launched into the circulation piping 3. The first and second selector valves 25a and 25b each consist of a three-way selector valve.

The first selector valve 25a has, in a housing 28, a spherical valve element 30 and a valve seat 31 that slidingly comes into contact with the valve element 30. The valve element 30 is formed with a passage 30a, which has a diameter equal to the inside diameter of the circulation piping 3, therein, and can open and close the paint passage of the circulation piping 3 by means of the rotation thereof. The valve seat 31 and the valve element 30 are held in the housing 28 in a liquid-tight manner by a port 32 threadedly engaging with the threaded hole in the housing 28, and the port 32 is also formed with a passage 32a that is a part of the circulation piping 3. The inside diameter of the passage 32a is equal to the inside diameter of the circulation piping 3.

The valve element 30 of the first selector valve 25a is opened and closed in association with the operation of a first cock 33a (FIG. 1) provided on the outer surface of the housing 28, and the valve element 30 of the second selector valve 25b is opened and closed in association with the operation of a second cock 33b (FIG. 1).

The configuration of the second selector valve 25b in the housing 28 is the same as that of the first selector valve 25a. With the opening part of the port 32, an adapter 34a constituting a quick joint 34 is threadedly engaged. The adapter 34a is formed with a connection hole that allows a sleeve 34b to be fittingly connected. In the sleeve 34b, a pig launching passage i having a diameter equal to the inside diameter of the circulation piping 3 is formed.

The pig 27 can be inserted into the pig launching passage i.

Therefore, in the state in which the sleeve 34b of the quick joint 34 is fittingly connected to the connection hole in the adapter 34a as shown in FIG. 7, the pig launching passage i communicates with the passage 32a of the port 32. In this state, the valve element 30 of the second selector valve 25b is operated to allow the port 32 to communicate with the circulation piping 3. After the pig 27 has been inserted into the pig launching passage i, the cleaning solution fed under pressure from the cleaning solution supply part 36 is supplied to the rear of the pig 27, by which the pig 27 is run by the pressing force of the cleaning solution to clean the inner wall of the circulation piping 3 by peeling off the paint depositing thereon.

The pig discharging valve 26 includes, as shown in FIG. 1, a first cock 33a for opening and closing the return pipe 3b on the downstream side of the pig discharging valve 26 and a second cock 33b that can change the passage so as to guide the pig 27 to the discharge pipe 3c side. The construction and operation of the first and second cocks 33a and 33b are the same as those of the first selector valve 25a and the second selector valve 25b. That is to say, as for the operation, the valve elements 30 of a first selector valve 26a and a second selector valve 26b are opened and closed in association with the operation of the first cock 33a and the second cock 33b.

Also, on the downstream side of the discharge pipe 3c, a recovery tank 35 for recovering the discharged pig 27 and the cleaning waste solution is disposed.

The pig 27 is formed of a shell-shaped or spherical resin material having a diameter equal to the inside diameter of the circulation piping 3. Since the pig 27 is used repeatedly by being cleaned after every use, a material to which the paint is less liable to stick, such as fluorocarbon resin or polypropylene resin, is preferably used for the pig 27. Also, for the pig 27, a sponge etc. having proper elasticity can be used so that the pig 27 comes into close contact with the inner wall even in a corner part of the circulation piping 3. As one example of the sponge, for example, urethane, rubber, or polyethylene resin can be thought of.

Also, a plurality of pigs 27 having different material properties can be launched. For example, if the fluorocarbon resin pig, the cleaning solution, the sponge pig, and the cleaning solution are introduced in succession toward the advance direction, an effect such that the depositing paint is peeled off by the fluorocarbon resin pig, the peeled-off paint is cleaned with the cleaning solution, and the paint remaining in the piping is cleaned with the sponge is achieved. Therefore, the place that is difficult to clean, such as the corner part, can also be cleaned satisfactorily.

The corner part of the circulation piping 3 preferably has a curvature of some degree so that the pig 27 surely comes into contact with the inner wall surface.

Next, the operation etc. of the above-described paint supply system at the time of paint circulation, at the time of painting, and at the time of pig cleaning are explained.

### (At the Time of Paint Circulation)

In the state in which the first selector valve 25a of the pig launching valve 25 is opened (turned to a communicating state), the second selector valve 25b thereof is closed, the first selector valve 26a of the pig discharging valve 26 is opened (turned to a communicating state), and the second selector valve 26b thereof is closed, the pump 6 is driven to close the first needle valve 13 and the second needle valve 14 of the color change valve 4. By doing this, the paint in the paint tank 2 is circulated in the paint circulation piping 3 so as to return again to the paint tank 2.

### (At the Time of Painting)

Air is supplied from the air supply holes 20 and 21 in the valve body 11 of the color change valve 4, and the first opening 10k and the second opening 12k are opened by retreating the first needle valve 13 and the second needle valve 14. By doing this, the paint is supplied to the paint gun 5 through the communication passage R and is sprayed.

### (At the Time of Pig Cleaning)

The first and second selector valves 25a and 25b of the pig launching valve 25 are closed, the first selector valve 26a of the pig discharging valve 26 is closed, the second selector valve 26b thereof is opened, and the pig 27 is inserted into the sleeve 34b of the quick joint 34. By connecting the sleeve 34b to the adapter 34a, the preparation of pig cleaning is conducted.

Then, the second selector valve 25b of the pig launching valve 25 is opened (turned to a communicating state), and the cleaning solution is supplied through the opening of the pig launching passage i of the sleeve 34b to run the pig 27. The inner wall of the circulation piping 3 is cleaned, and the pig 27 and the cleaning waste solution are recovered by the recovery tank 35.

At this time, since both of the pig launching valve 25 and the pig discharging valve 26 are located near the paint tank 2, the substantially entire region of the paint circulation piping 3 can be cleaned efficiently. Also, by locating the pig launching valve 25 and the pig discharging valve 26 at potions where the pig 27 can be launched and discharged linearly, the pig 27 can be run smoothly.

Also, since the paint peeled off the inner wall does not accumulate near the first opening 12k of the color change valve 4, clogging is less liable to occur.

In the above-described embodiment, the configuration is made such that the pig 27 is pushed out by the cleaning solution supplied to the rear of the pig 27. However, the configuration is not limited to this. For example, the pig 27 may be pushed out by compressed air. Besides, the pig 27 may be run after the cleaning solution has been caused to flow, or the pig 27, the cleaning solution, and the compressed air may be caused to flow in combination.

Further, the pig 27 may be pushed out by the paint pressure. In this case, the three-way valve shown in FIG. 1 is changed over to change the paint passage.

### INDUSTRIAL APPLICABILITY

A wide range of paint circulation piping can be cleaned with a pig, and the peeled-off paint is less liable to accumulate near the valve of a color change valve, so that a trouble such as clogging can be prevented effectively. Therefore, the paint supply system in accordance with the present invention is best suitable if it is applied to a vehicle body painting process in which a paint mixing chamber and a painting booth are located apart from each other.

1-2. (canceled)

3. A paint supply system in which a paint gun is connected to an intermediate portion of closed loop paint circulation piping, which is connected to a paint supply source, via a color change valve, and when the paint circulation piping is cleaned, a pig is run in the circulation piping, characterized in that the color change valve has a valve body capable of feeding the paint, which is fed from the paint circulation piping, into the paint passage of a manifold via a communication passage; the valve body is provided with a first needle valve which can open and close a first opening which is open to the paint circulation piping from the communication passage in the valve body and a second needle valve which can open and close a second opening which is open to the paint passage in the manifold from the communication passage in the valve body; and at least the first opening is arranged at a position close to the inner wall of the paint circulation piping.

4. The paint supply system according to claim 3, characterized in that in the intermediate portion of the paint circulation piping, a pump for feeding paint under pressure, a pig launching valve for launching the pig into the circulation piping, and a pig discharging valve for discharging the pig from the circulation piping are provided; the pig launching valve is provided at a place closest to the pump of the places where the pig can be launched into the paint circulation piping almost linearly; and the pig discharging valve is provided at a place closest to the paint supply source of the places where the pig can be discharged from the paint circulation piping almost linearly.
